(19) United States
(12) Patent Application Publication
(10) Pub. No.: US 2020/0164687 A1
(43) Pub. Date: May 28, 2020

(54) PNEUMATIC TIRE

(71) Applicant: Toyo Tire Corporation, Itami-shi (JP)

(72) Inventor: Satoshi Nishida, Itami-shi (JP)

(73) Assignee: Toyo Tire Corporation, Itami-shi (JP)

(21) Appl. No.: 16/656,080

(22) Filed: Oct. 17, 2019

(30) Foreign Application Priority Data
Nov. 28, 2018 (JP) 2018-222557
Nov. 28, 2018 (JP) 2018-222562

(51) Int. Cl. B60C 9/00

(52) U.S. Cl. CPC B60C 9/0042; B60C 2009/0085; B60C 2009/0092

(57) ABSTRACT

A pneumatic tire that can improve high speed durability while reducing a tire weight is provided. The pneumatic tire comprises a carcass, a belt layer comprising a cord inclined to a tire circumferential direction and arranged on the periphery of a crown of the carcass, and a belt reinforcing layer comprising an organic fiber cord arranged on the periphery of the belt layer along a tire circumferential direction. The organic fiber cord comprises an aromatic polyamide fiber having a fineness of 500 to 3,000 dtex, and has a single twist construction having a twist coefficient of 800 to 2,000.

### BACKGROUND ART

The present invention relates to a pneumatic tire.

Pneumatic tire is being considered to improve its rigidity in a tire circumferential direction for the purpose of improving durability during high speed running (hereinafter referred to as “high speed durability”).

Organic fiber cord is sometimes used in a belt reinforcing layer in order to reduce a tire weight. In this case, to improve rigidity in a circumferential direction of a tire, it is necessary to increase the fineness of an organic fiber cord or to increase driven number of organic fiber cord. However, there was the problem that those lead to the increase of a tire weight.

### PATENT LITERATURE

PTL 1: JP-A-2016-68822

PTL 2: JP-A-2014-201136

PTL 3: JP-A-2013-43612

### SUMMARY OF INVENTION

The present invention has been made in view of the above circumstances, and an object of the present invention is to provide a pneumatic tire that can improve high speed durability while reducing a tire weight.

Regarding a pneumatic tire with a belt reinforcing layer comprising an organic fiber cord, Patent Literature 1 describes a pneumatic tire for achieving both flat spot resistance and abrasion resistance, but high speed durability is not discussed. In addition, the organic fiber cord comprises aliphatic polyamide, and the effect of improving high speed durability is insufficient.

Patent Literature 2 describes a pneumatic tire for improving high speed durability in addition to the suppression of air stagnation, but does not contain the description of a twist coefficient of an organic fiber cord.

Patent Literature 3 describes a pneumatic tire with a belt cover layer having a reinforcing core body having a given construction in order to improve rolling resistance while improving high speed durability. The reinforcing core body has warps comprising a single twist cord obtained by twisting an organic fiber multifilament yarn in one direction, and an aramid fiber is described as one example of its material. However, a twist coefficient of an organic fiber cord is not described.

The pneumatic tire according to the present invention comprises a carcass, a belt layer comprising a cord inclined to a tire circumferential direction and arranged on the periphery of a crown of the carcass, and a belt reinforcing layer comprising an organic fiber cord arranged on the periphery of the belt layer along a tire circumferential direction, wherein the organic fiber cord comprises an aromatic polyamide fiber having a fineness of 500 to 3,000 dtex, and has a single twist construction having a twist coefficient of 800 to 2,000.

A product (N/25 mm) of a load (N) at 2% elongation per the organic fiber cord and driven number (numbers/25 mm) of the organic fiber cord in the belt reinforcing layer is 350 to 650 N/25 mm.

According to the pneumatic tire of the present invention, excellent high speed durability is achieved while reducing a tire weight.

### BRIEF DESCRIPTION OF DRAWINGS

FIG. 1 is a half-sectional view of a pneumatic tire according to an embodiment of the present invention.

### DESCRIPTION OF EMBODIMENTS

The present invention is described in detail below.

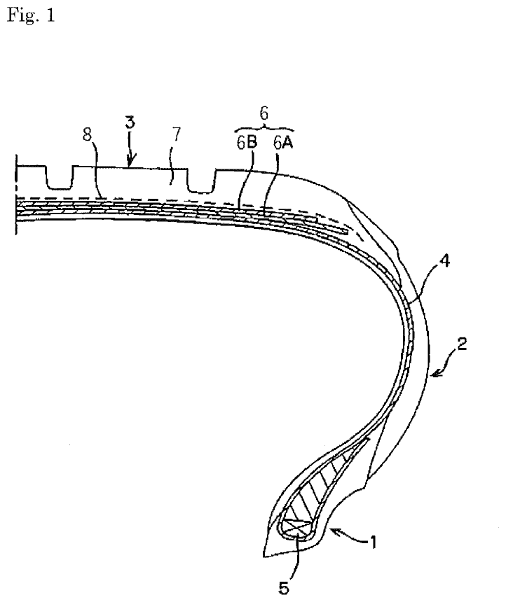

The pneumatic tire of the embodiment shown in FIG. 1 is a pneumatic radial tire for passenger cars, and comprises a pair of right and left bead parts 1, a sidewall part 2, a tread part 3 provided between both sidewall parts so as to connect external edges in a radial direction of right and left sidewall parts 2 to each other, and a carcass 4 extending across a pair of the bead parts.

The carcass 4 comprises at least one carcass ply, both edges of which being locked with a ring-shaped bead core 5 embedded in the bead part 1 through the sidewall part 2 from the tread part 3. The carcass ply comprises a carcass cord comprising an organic fiber cord, arranged at substantially right angle to a tire circumferential direction.

A belt 6 is provided between the carcass 4 and a tread rubber part 7 at a periphery side (that is, outside a tire radial direction) of the carcass 4 in the tread part 3. The belt 6 is piled and provided on the periphery of a crown of the carcass 4, and can be constituted of one or a plurality of belt plies, generally at least two belt plies. In this embodiment, the belt is constituted of two belt plies of a first belt ply 6A at a carcass side and a second belt ply 6B at a tread rubber part side. The belt plies 6A and 6B comprise steel cords that are inclined at a given angle (for example, 15 to 35°) to a tire circumferential direction and arranged at given intervals in a tire width direction. Each belt ply comprises steel cords covered with a coating rubber. The steel cords are arranged so as to cross each other between the two belt plies 6A and 6B.

A belt reinforcing layer 8 is provided between the belt 6 and the tread rubber part 7 at a periphery side (that is, outside a tire radial direction) of the belt 6. The belt reinforcing layer 8 is a cap ply covering the entire width of the belt 6 by a belt reinforcing ply, and comprises organic fiber cords arranged in substantially parallel to a tire circumference direction. In other words, the belt reinforcing layer 8 comprises organic fiber cords arranged along a tire circumference direction, and can be formed by spirally winding the organic fiber cords at an angle of 0 to 5° to the tire circumference direction so as to cover the entire width direction of the belt 6.

The organic fiber cord constituting the belt reinforcing layer 8 according to this embodiment comprises an aromatic polyamide fiber. The aromatic polyamide fiber is a poly amide having an aromatic skeleton in a main chain. The polyamide may be para-aramid and may be meta-aramid. For example, the conventional aramid fiber used in the present technical field can be appropriately used.

A cord of a single twist construction comprising the aromatic polyamide fibers is used as the organic polyamide fiber. Specifically, the organic fiber cord of a single twist construction in which a twist in one direction has been imparted to a yarn comprising a bundle of many aromatic polyamide filaments is used. When the organic fiber cord has a single twist construction, cord volume can be decreased and the thickness of the belt reinforcing layer 8 can be reduced, as compared with the case of using an organic fiber cord of a double twist construction. As a result, a tire weight is easy to be reduced.

The fineness of the organic fiber cord is not particularly limited so long as the fineness is 500 to 3,000 dtex. The fineness is preferably 700 to 2,800 dtex and more preferably 800 to 2,800 dtex. When the fineness is 500 dtex or more, the driven number of organic fiber cords necessary for obtaining desired tire performance is easy to be decreased. As a result, adhesive failure between the organic fiber cord and rubber in a cut end part of a belt reinforcing ply is difficult to be generated, and excellent high speed durability and tire's load durability are easily to be obtained. On the other hand, when the fineness is 3,000 dtex or less, a tire weight is easy to be decreased. The fineness used herein is called nominal fineness.

Twist coefficient (K) of the organic fiber cord is not particularly limited so long as it is 800 to 2,000. The twist coefficient is preferably 900 to 1,900. When the twist coefficient is 800 or more, fatigue resistance of the organic fiber cord can be maintained, and excellent high speed durability and tire's load durability are easy to be obtained. On the other hand, when the fineness is 2,000 or less, strength of a belt reinforcing ply can be maintained, and the driven number of organic fiber cords necessary for obtaining desired tire performance is easy to be decreased. As a result, separation between the belt 6A and the belt 6B at the edges in a width direction of the belt 6, separation between the belt 6 and the belt reinforcing layer 8, and separation between the belt 6 and the carcass 4 are difficult to be generated, and excellent high speed durability and tire's load durability are easy to be obtained.

The twist coefficient (K) used herein is represented by the following formula (1):

K=T(D/P)^{1/2} (1)

wherein T is the number of twist per 10 cm (numbers/10 cm), D is a nominal fineness (dtex) and P is a density (g/cm³) of an aromatic polyamide fiber.

The number of twist per 10 cm (numbers/10 cm) of the organic fiber cord is not particularly limited, and is generally 25 to 70 numbers/10 cm and preferably 25 to 60 numbers/10 cm.

The driven number of the organic fiber cords (numbers/25 mm) is not particularly limited, and is generally 8 to 24 numbers/25 mm and preferably 8 to 21 numbers/25 mm.

In this embodiment, the organic fiber cord is that a product S (that is, S=L×E) of a load L (N) at 2% elongation thereof and the driven number E (numbers/25 mm) of the organic fiber cords in the belt reinforcing layer 8 is 350 to 650 N/25 mm. The product S is an index of strength to tension per width of the belt reinforcing layer 8 in a relatively low tensile region, such as at tire molding or at tire actual running. When the product S is 350 N/25 mm or more, the belt reinforcing layer 8 suppresses rising-up of the belt 6, good ground contact shape can be maintained, and excellent driving stability is easy to be obtained. On the other hand, when the product S is 650 N/25 mm or less, rigidity of the belt reinforcing ply does not become excessively high, and excellent tire's load durability is easy to be obtained. The product S is preferably 350 to 600 N/25 mm and more preferably 350 to 550 N/25 mm.

The load L at 2% elongation of the organic fiber cord is not particularly limited, and is, for example, generally 20 to 50 N and preferably 20 to 45 N. The value of the load at 2% elongation can be adjusted by, for example, adjusting a nominal fineness or the number of twist depending on elasticity of the aromatic polyamide fiber constituting the organic fiber cord, or adjusting the kind and deposition amount of the conventional adhesive treatment liquid such as RFL (resorcin-formalin-latex) treatment liquid. The load at 2% elongation used herein is a value measured by conducting a tensile test in accordance with JIS L1017 in a test room under the standard conditions of temperature: 20±2° C. and relative humidity: (65±4)% defined in JIS L0105.

The driven number (end number) E of organic fiber cords is not particularly limited, and can be appropriately set so as to satisfy the above range of the product S depending on the value of a load at 2% elongation. The driven number E is, for example, 5 to 40 numbers/25 mm, preferably 5 to 30 numbers/25 mm and more preferably 5 to 25 numbers/25 mm.

The kind of the pneumatic tire according to the present invention is not particularly limited, and includes various tires such as tires for passenger cars and tires for heavy load used in trucks, buses and the like.

The above embodiment describes an embodiment that the belt reinforcing layer 8 is a cap ply covering the entire width of the belt 6, but the present invention is not limited to this. The belt reinforcing layer may be, an edge ply covering edges outside a tire width direction of the belt 6 and its periphery and may be an edge ply comprising folded parts of both edges in a tire width direction of the cap ply.

### Example

The present invention is described in detail below by reference to examples, but it should be understood that the invention is not construed as being limited to those examples.

Organic fiber cords having the respective construction and twist number as shown in Tables 1 and 2 were prepared. The organic fiber cords prepared were arranged in the driven number shown in Tables 1 and 2, and a rubber member with cords was formed using a calendaring apparatus. Thus, a belt reinforcing ply was prepared.

Measurement methods of the organic fiber cord and belt reinforcing ply are described below.

Cord diameter: One organic fiber cord was bent such that a twist does not return, thereby forming four organic fiber cords. Those were parallelly arranged so as not to sag. Using a given dial gauge (diameter of leg (gauge head): 9.5±0.03 mm, load: 1,666±29.4 mN), the leg was dropped to the cords from a height of about 6.5 mm, and the cord diameter was measured.

Cord strength (tensile strength): Measured by conducting a tensile test in accordance with JIS L1017 in a test room under the standard conditions of temperature: 20±2° C. and relative humidity: (65±4)% defined in JIS L0105

Load (N) at 2% elongation: Tensile test in accordance with JIS L1017 of an organic fiber cord was conducted in a test room under the standard conditions of temperature: 20±2° C. and relative humidity: (65±4)% defined in JIS L0105, and load at 2% elongation was measured.

Thickness of belt reinforcing ply: Belt reinforcing layer member before vulcanization was put such that the member does not sag. Using a given dial gauge (diameter of leg (gauge head): 9.5±0.03 mm, load: 1,666±29.4 mN), the leg was dropped from a height of about 6.5 mm, and thickness of the member was measured.

Total ply strength: Tensile strength per 25 mm width of a belt reinforcing layer calculated by multiplying the driven number in a belt reinforcing layer and the number of ply by cord strength

Using the belt reinforcing ply obtained, a radial tire having a tire size of 205/65R15 was vulcanization molded according to the conventional method. Each tire had the common construction except for the belt reinforcing layer. An angle of the cord in the belt ply was +21°/−21° to a tire circumferential direction. The belt reinforcing layer was arranged on the periphery of the belt layer such that a major axis of the organic fiber cord is in parallel to a belt surface.

The carcass ply was that an organic fiber cord comprising a polyester, having a cord construction of 1,670 dtex/2 was considered as one ply with the driven number 24 numbers/25 mm.

Tire weight, high speed durability, tire's load durability and driving stability of each pneumatic tire obtained were evaluated. The evaluation method of each evaluation item is described below.

Tire weight: The weight is total weight per one tire, and was indicated by an index as the total weight of the tire of the conventional example being 100. The weight is small as the index value is small.

High speed durability: Measured in accordance with FTV SS109 (UTQG).

Specifically, high speed durability test was conducted using a drum tester made of iron having a smooth surface and having a diameter of 1,700 mm. Inner pressure of a tire was 220 kPa, and a load was 88% of the maximum load defined in JATMA. Running-in was performed in a speed of 80 km/hour for 60 minutes, the tire was naturally cooled, air pressure was again adjusted, and main running was then performed. The main running was started from 120 km/hour, the speed was stepwise increased 8 km/hour every 30 minutes, and the running was continued until generating breakdown. The running distance until generating breakdown was indicated by an index as the evaluation result of the tire of Comparative Example 1 being 100. High speed durability is satisfactory as the numerical value is large.

Tire's load durability: Test was conducted using a drum tester made of iron having smooth surface and having a diameter of 1,700 mm in accordance with the conditions specified as a durability test in Federal Motor Vehicle Safety Standards FMVSS 139. A tire having a size of 195/65R15 was used as a test tire. The tire inner pressure was 220 kPa, the speed was 120 km/hour, and the load was the maximum load defined in JATMA as a standard load. Running was performed under a load of 85% for 4 hours, under a load of 90% for 6 hours and under a load of 100% for 24 hours. Thereafter, the running was performed under the conditions of speed: 81 km/hour, inner pressure: 220 kPa and load: 120% for 6 hours. In this test, when abnormality was not observed in appearance and inner surface, the load was further increased to 140% and the running was performed until generating breakdown. The running distance until generating breakdown was indicated by an index as the evaluation result of the tire of Comparative Example 1 being 100. The distance until generating breakdown is long and tire's load durability is excellent, as the value is large.

Driving stability: Each tire having an inner pressure of 200 kPa was mounted on a test vehicle of 2,000 cc displacement, the test vehicle was run on a test course by three professional test drivers, and feeling was evaluated. The scoring was 10-level evaluation, and the driving stability was evaluated by relative evaluation as the evaluation result of the tire of Conventional Example being 6. An average of three drivers was indicated by an index as the evaluation result of the tire of Comparative Example 1 being 100. The index means that driving stability is excellent as the value is large.

TABLE 1

| | Conventional | | | | |
|---|---|---|---|---|---|
| | Example | Example 1 | Example 2 | Example 3 | Example 4 |
| Cord material | Nylon 6,6 | Aramid | Aramid | Aramid | Aramid |
| Cord construction | 940 dtex/2 | 1100 dtex/1 | 1100 dtex/1 | 830 dtex/1 | 2800 dtex/1 |
| Fineness (dtex) | 1880 | 1100 | 1100 | 830 | 2800 |
| Number of twist (numbers/10 cm) | 45 | 34 | 60 | 55 | 28 |
| Twist coefficient | 1827 | 940 | 1658 | 1320 | 1235 |
| Cord diameter (mm) | 0.53 | 0.26 | 0.32 | 0.25 | 0.44 |
| Cord strength (N) | 145 | 160 | 124 | 124 | 330 |
| Load at 2% elongation (N) | 11.1 | 30.3 | 22.1 | 25.7 | 44.7 |
| Driven number (numbers/25 mm) | 18 | 16 | 21 | 21 | 8 |
| Product of load at 2% elongation (N) | 200 | 485 | 464 | 540 | 358 |
| and driven number (numbers/25 mm) | | | | | |
| Thickness of belt reinforcing ply (mm) | 0.82 | 0.55 | 0.61 | 0.54 | 0.73 |
| Total ply strength (N) | 2610 | 2560 | 2604 | 2604 | 2640 |
| Tire weight (index) | 100.0 | 99.1 | 99.4 | 99.1 | 99.7 |
| High speed durability | 100 | 107 | 107 | 110 | 106 |
| Tire's load durability | 100 | 100 | 100 | 100 | 100 |
| Driving stability | 100 | 111 | 111 | 111 | 106 |

TABLE 2

| | Comparative | Comparative | Comparative | Comparative | Comparative |
|---|---|---|---|---|---|
| | Example 1 | Example 2 | Example 2 | Example 4 | Example 5 |
| Cord material | Nylon 6,6 | Aramid | Aramid | Aramid | Aramid |
| Cord construction | 1400 dtex/1 | 440 dtex/1 | 3300 dtex/1 | 1100 dtex/1 | 1100 dtex/1 |
| Fineness (dtex) | 1400 | 440 | 3300 | 1100 | 1100 |
| Number of twist (numbers/10 cm) | 35 | 55 | 21 | 22 | 75 |
| Twist coefficient | 1227 | 961 | 1005 | 608 | 2073 |
| Cord diameter (mm) | 0.38 | 0.19 | 0.61 | 0.25 | 0.33 |
| Cord strength (N) | 111 | 53 | 451 | 175 | 76 |
| Load at 2% elongation (N) | 9.6 | 13.0 | 59.8 | 35.7 | 18.8 |
| Driven number (numbers/25 mm) | 24 | 49 | 6 | 15 | 34 |
| Product of load at 2% elongation (N) | 230 | 637 | 359 | 536 | 639 |
| and driven number (numbers/25 mm) | | | | | |
| Thickness of belt reinforcing ply (mm) | 0.67 | 0.48 | 0.90 | 0.54 | 0.62 |
| Total ply strength (N) | 2664 | 2597 | 2706 | 2625 | 2584 |
| Tire weight (index) | 99.5 | 98.9 | 100.3 | 99.1 | 99.5 |
| High speed durability | 100 | 93 | 105 | 96 | 90 |
| Tire's load durability | 100 | 97 | 100 | 97 | 94 |
| Driving stability | 100 | 111 | 106 | 111 | 111 |

The results obtained are shown in Tables 1 and 2 above. It was understood that as compared with Conventional Example using an organic fiber cord comprising Nylon 6,6 and having a double twist construction of 940 dtex/2, Examples 1 to 4 each are that the tire weight can be reduced, the tire's load durability can be maintained, and excellent high speed durability and driving stability are obtained.

Comparative Example 1 is the organic fiber cord of a single twist construction, in which the fineness and twist coefficient are within given ranges, but the material of the cord is Nylon 6,6. As compared with Conventional Example, the improvement effect was not recognized in high speed durability, tire's load durability and driving stability.

Comparative Example 2 is an example in which the fineness of the organic fiber cord is less than the lower limit, and high speed durability and tire's load durability were poor as compared with Conventional Example.

Comparative Example 3 is an example in which the fineness of the organic fiber cord exceeds the upper limit, and tire weight was increased as compared with Conventional Example.

Comparative Example 4 is an example in which the twist coefficient of the organic fiber cord is less than the lower limit, and high speed durability and tire's load durability were poor as compared with Conventional Example.

Comparative Example 5 is an example in which the twist coefficient of the organic fiber cord exceeds the upper limit, and high speed durability and tire's load durability were poor as compared with Conventional Example.

The pneumatic tire of the present invention can be used in various vehicles such as passenger cars, light trucks and buses.

### REFERENCE SIGNS LIST

1: Bead part
2: Sidewall part
3: Tread part
4: Carcass
5: Bead core
6: Belt
6A: First belt ply
6B: Second belt ply
7: Tread rubber part
8: Belt reinforcing layer

1. A pneumatic tire comprising a carcass, a belt layer comprising a cord inclined to a tire circumferential direction and arranged on the periphery of a crown of the carcass, and a belt reinforcing layer comprising an organic fiber cord arranged on the periphery of the belt layer along a tire circumferential direction,
wherein the organic fiber cord comprises an aromatic polyamide fiber having a fineness of 500 to 3,000 dtex, and has a single twist construction having a twist coefficient of 800 to 2,000.

2. The pneumatic tire according to claim 1, wherein a product (N/25 mm) of a load (N) at 2% elongation per the organic fiber cord and driven number (numbers/25 mm) of the organic fiber cord in the belt reinforcing layer is 350 to 650 N/25 mm.
